(19) United States
(12) Patent Application Publication
(10) Pub. No.: US 2004/0083589 A1
(43) Pub. Date: May 6, 2004

(54) Method for the producing electrodes, components, half cells and cells for eletrochemical energy converters

(76) Inventors: Marc Steinfort, Ismaning (DE); Marc Bednarz, Taufkirchen (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/451,418

(22) PCT Filed: Dec. 18, 2001
(86) PCT No.: PCT/EP01/14911

(30) Foreign Application Priority Data
Dec. 22, 2000 (DE) 100-64-462.7

(51) Int. Cl. H01G 9/00; B05D 5/12

(52) U.S. Cl. 29/25.03; 427/80; 427/359; 427/369

(57) ABSTRACT

The invention relates to a method for producing electrodes, components, half cells and cells for electrochemical energy converters, such as fuel cells or electrolysis cells, comprising the following steps: a) producing a plane, porous support material (4a; 4b); b) applying at least one layer of an electrode material (1) and/or a layer of a catalyst material (18) to the porous support material (4a); c) rolling or pressing said porous support material (4a) together with the layers applied thereto to a predetermined thickness (D), at the same time producing a flat and smooth or structured surface.

This invention concerns a method for manufacturing electrodes, components, half-cells and cells for electrochemical energy converters.

Traditionally, highly complex and costly processes are required for manufacturing electrodes, components, half-cells and cells for electrochemical energy converters, e.g., for fuel cell arrangements or electrolytic cell arrangements. The components are produced individually in various manufacturing processes and in part subjected to elaborate high-temperature processes, such as firing, sintering, and melt filling in a controlled gas atmosphere. Electrodes and components for the production of fuel cells or cells for electrolytic applications are usually manufactured by foil casting and dry packed-bed techniques. After a series of further process and treatment steps, they are then combined to form half-cells, cells and cell stacks. It is the purpose of this invention to provide a simplified method for the manufacture of electrodes, components, half-cells and cells for electrochemical energy converters.

The invention meets said purpose through the method described in claim 1.

Advantageous designs of the invented method are specified in the dependent claims.

The invention provides a method for the manufacture of electrodes, components, half-cells and cells for electrochemical energy converters. According to the invention, the method includes the following procedures:

a) Fabricating a flat-shaped, porous carrier material;

b) Depositing a minimum of one layer of electrode material and/or one layer of catalyst material on the porous carrier material;

c) Rolling or pressing the porous carrier material together with the layer of electrode material and/or the layer of catalyst material deposited thereon to a predetermined thickness and producing a level and smooth or structured surface.

A major benefit of the method, according to the invention, is the significant decrease in the number of necessary procedure steps for manufacturing the above-mentioned items. It is therefore possible to omit costly high-temperature steps in a controlled gas atmosphere.

In step c), the porous carrier material, together with the layer of electrode material and/or the layer of catalyst material deposited thereon, is rolled or pressed to a predetermined thickness that is smaller than the original thickness prior to rolling or pressing.

Due to an extremely advantageous aspect of the invented method, the porous carrier material may be textured and/or profiled.

According to a preferred design, texturing can be achieved in step c) by rolling or pressing with a profiling element.

According to an alternative design, texturing by rolling or pressing with a profiling element may also be carried out in an additional step d).

In this latter variation, rolling or pressing with the profiling element according to the additional step d) would be performed subsequent to rolling or pressing according to step c).

As a result of this advantageous aspect of the invented method, the texturing provides gas flow channels on the porous carrier material, which serves to feed or draw off the gas converted by the electrochemical energy converter.

In one variation of the invented method, the profiling element producing the texturing is a roller or a press part provided with a profiled surface.

As an alternative, highly advantageous design, the profiling element producing the texturing is a separate part that passes between a roller and the porous carrier material.

According to a preferred design of the invented method, the profiling element producing the texturing is a grid or a flat-shaped profile.

According to a design hereof, the profiling element producing the texturing is plate-shaped.

In an alternative, highly advantageous design, the profiling element producing the texturing is a rotating band that rotates between the roller and the porous carrier material.

Additional variations of the invented method provide for drying, firing or sintering prior to rolling or pressing.

Further variations of the invented method provide for firing or sintering subsequent to rolling or pressing.

In an additional, advantageous advancement of the invented method, a layer of electrode material is deposited on one side of the porous carrier material, and a layer of catalyst material is deposited on the opposite side of the porous carrier material.

Also proposed by this invention, a layer of electrode material is deposited on the porous carrier material, and a layer of electrolyte matrix material may be deposited on the layer of electrode material.

The porous carrier material consists of porous sinter metal or metal foam produced via carbonyl process, precipitation, galvanizing or foaming. The metal can precipitate on preformed polyurethane foam by galvanic, chemical, PVD and CVD process.

In one highly advantageous variation of the invented method, the layer of electrode material and/or the layer of catalyst material are deposited by means of spraying a sprayable electrode raw material or a sprayable catalyst material.

According to an alternative design of the invented method, the layer of electrode material is deposited by applying a viscous or pasty electrode raw material onto the carrier material. According to another alternative design of the invented method, the layer of electrode material is deposited on the porous carrier material by casting, foil casting or dipping of a liquid electrode raw material.

In a further highly advantageous variant of the invention, the layer of electrolyte matrix material is deposited by spraying a sprayable matrix raw material.

As an alternative design of the invented method, the layer of electrolyte matrix material is deposited by applying, casting or foil casting of a liquid, viscous or ductile matrix raw material.

According to a highly advantageous aspect of the invention, the invented method is used for the manufacture of electrodes, components, half-cells or cells for a fuel cell arrangement.

As another highly advantageous aspect of the invention, the invented method is used for the manufacture of electrodes, components, half-cells and cells for an electrolyte cell arrangement.

In the following, designs of the invention are discussed based on the drawings:

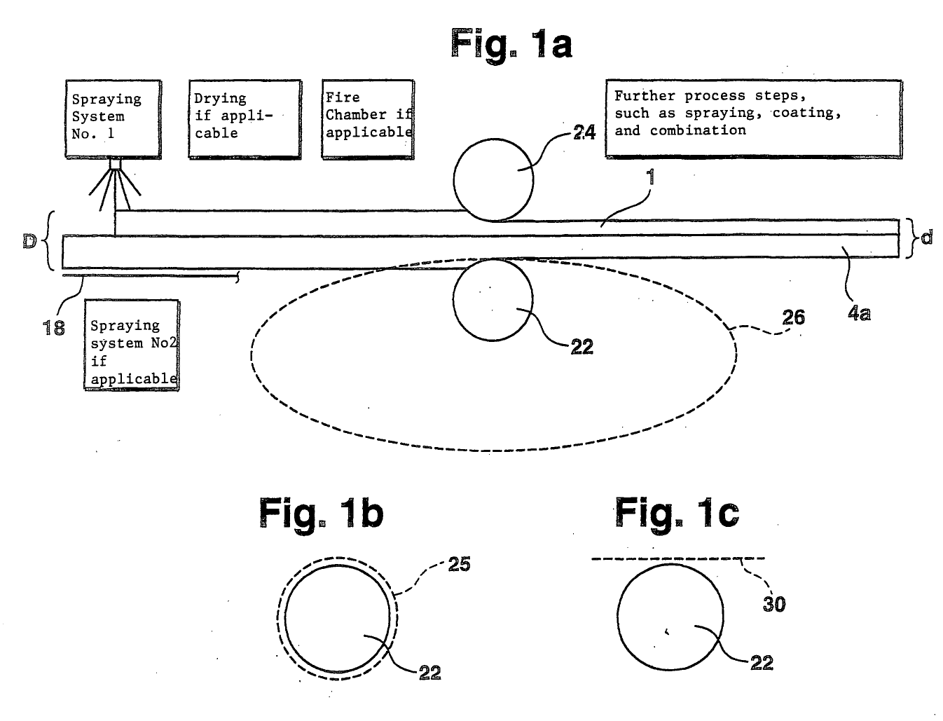

FIG. 1 is a schematic illustration of a first design of the invented method, while FIGS. 1a), b) and c) show modifications thereof.

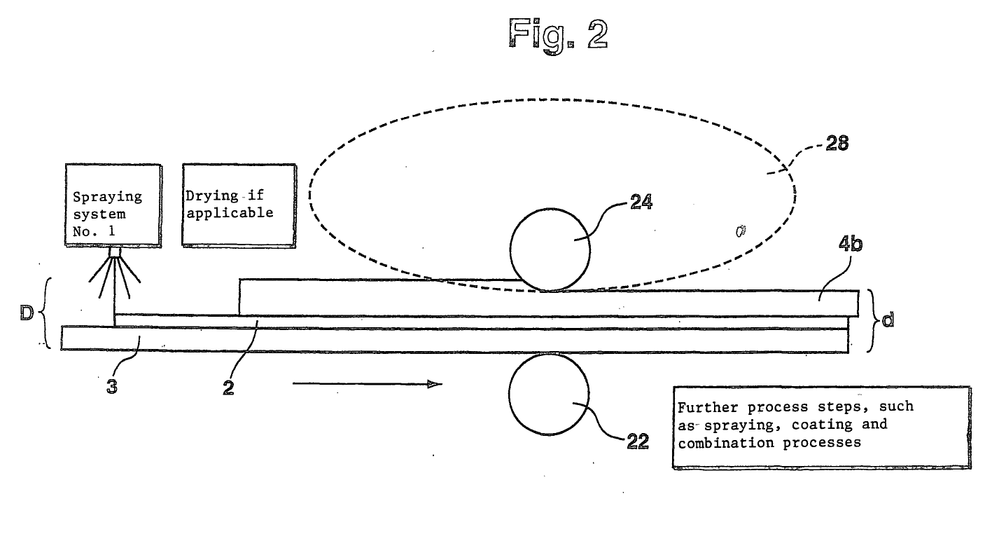

FIG. 2 is a schematic illustration of a second design of the invented method.

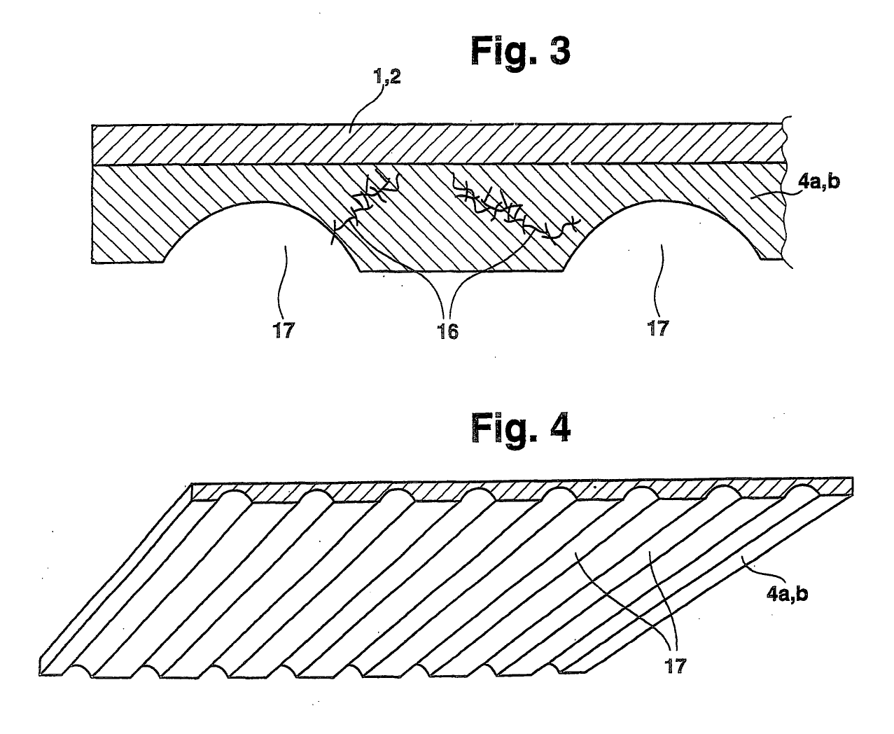

FIGS. 3 and 4 represent a section of FIG. 1, in an enlarged schematic cross-section view, showing a layer of electrode material on a layer of porous carrier material, and a perspective illustration of solely the carrier material, respectively.

FIG. 1 is a schematic illustration of the implementation of the method for the manufacture of electrodes, components, half-cells and cells for electrochemical energy converters, according to a design of the invention. The present case could, as a result, serve in the manufacture of a half-cell for a molten carbonate fuel cell (MCFC). Number 4a refers to a flat-shaped, porous carrier material manufactured by a carbonyl process, precipitation, galvanization or foaming. The carrier material consists of a nickel foam material with a solid content of between 4% and 35%, or a porous nickel sinter material.

A layer of electrode material 1 is deposited on the porous carrier material 4a. In the illustrated design, the electrode material 1 is preferably a layer of anode material. The porous carrier material 4a, together with the layer of electrode material 1 deposited thereon, is rolled to a predetermined thickness d by means of rollers 22, 24. The two rollers 22, 24 can be placed opposite each other. The predetermined thickness d, to which the porous carrier material 4a together with the layer of electrode material 1 is rolled, is, therefore, smaller than the original thickness D prior to rolling. Alternatively (not shown), instead of rolling, a level or structured surface can be achieved through pressing. Rolling can always be substituted by pressing. Rolling or pressing both reduces the thickness of the porous carrier material and/or the electrode material.

In the porous carrier material 4, a profiling element produces texturing on the side opposite the electrode 1. In the design illustrated in FIG. 1a), the profiling element 26 is a separate part, in form of a grid or a flat-shaped profile that rotates as a rotating band between the roller 24 and the porous carrier material.

When a press is used, instead of a rotating band, a flat part is inserted similarly between a press part and the carrier material.

Alternatively, as shown in FIG. 1b), the profiling element is formed by a roller 25 or a part of the press, the surface of which is provided with profiling 29, and is used instead of the roller 22 in FIG. 1a).

In another alternative, as shown in FIG. 1c), the profiling element producing the texturing is formed by a separate part 30, which is designed as a grid or a flat-shaped profile, is plate-shaped and passes between the roller 22 and the porous carrier material 4a.

In the variations shown in FIG. 1a) through c), the texturing is produced by rolling with the profiling element 26 (FIG. 1a)), or profiling element 25, 29 (FIG. 1b)), or profiling element 30 (FIG. 1c)), during rolling of the porous carrier material 4a, together with the layer of electrode material 1, to the predetermined thickness d.

Alternatively, texturing is produced by rolling with an appropriate profiling element 26; 25, 29; 30, during an additional process step, which would be performed subsequent to rolling to the predetermined thickness d.

On the left side of FIG. 1a) another variation can be viewed, wherein a layer of catalyst material 18 is deposited on the porous carrier material 4a, namely on the side of the porous carrier material opposite to the electrode 1. The catalyst layer 18 is of such nature that it serves the internal reforming of fuel gas inside a fuel cell arrangement, while electrode 1 forms the anode and the catalyst layer 18 is located on the opposite side on the porous carrier material 4a. In this case, the porous carrier material 4a, together with the layer of electrode material 1 and the layer of catalyst material 18, is then rolled to the predetermined thickness d. This produces a level and smooth or structured surface, with the exception that texturing may be made by the profiling element 26; 25, 29; 30.

Depositing the layer of electrode material 1 is preferably performed by spraying a sprayable electrode raw material. Likewise, depositing an optionally provided layer of catalyst material 18 is performed by spraying a sprayable catalyst material.

Additionally, as shown in FIG. 1, further process steps can be performed in the manufacture of electrodes, components, half-cells or cells for electrochemical energy converters. Prior to rolling, processes such as drying, firing or sintering can be performed. Subsequent to rolling, processes such as firing, sintering, spraying, coating or combination processes can also be carried out.

FIG. 2 shows a design of the invented method, wherein similar to FIG. 1, a layer of electrode material 2 is deposited on a porous carrier material 4b. The porous carrier material 4b, together with the electrode material 2, is rolled to a predetermined thickness d, producing a level and smooth surface.

In addition to the layer of electrode material 2, however, a layer of electrolyte matrix material 3 is deposited on the porous carrier material 4b. In the illustrated variation, the layer of electrode material 2 may be electrode material for a cathode, so that the porous carrier material 4b carries the cathode 2, and the cathode 2 carries the electrolyte matrix 3. The porous carrier material 4b, together with the layer of electrode material 2 and the layer of the electrolyte matrix material 3 on top, is rolled to the predetermined thickness d, which is smaller than the original thickness D of these layers prior to rolling.

A profiling element 28 produces texturing in the porous carrier material 4b. In the illustrated design, the profiling element 28 is formed by a separate part provided as a grid or a flat-shaped profile and is a member that rotates between the roller 24 and the porous carrier material 4b.

Similar to the designs shown in FIGS. 1a) through c), the profiling element can also be a roller with a profiled surface that is used instead of the roller 24 in FIG. 2, the profiling element used for texturing can be a separate part in form of a grid or a flat-shaped profile, is plate-shaped and passes between the roller 24 and the porous carrier material 4b.

The texturing is produced during rolling of the porous carrier material 4b, together with the layers deposited thereon, to the predetermined thickness d. Alternatively, the texturing can be produced by rolling with an appropriate profiling element during an additional process step, which is then performed subsequent to rolling to the predetermined thickness d.

As in the design shown in FIG. 1, an additional drying, firing or sintering process can be performed prior to rolling, or other process steps such as spraying, coating or combination processes can also be carried out.

As in the variation shown in FIG. 1, the flat-shaped porous carrier material 4b can be produced by a carbonyl process, precipitation, galvanization or foaming. The layer of electrode material 2 is preferably deposited by spraying a sprayable raw material. Alternatively, the layer of electrode material 2 is deposited on the porous carrier material 4b by applying viscous or pasty electrode raw material.

In another alternative, the layer of electrode material 2 is deposited on the porous carrier material 4b by casting, foil casting or dipping of a liquid electrode raw material.

The layer of electrolyte matrix material 3 is preferably deposited by spraying a sprayable matrix raw material. Alternatively, the layer of electrolyte matrix material 3 is deposited by applying, casting or foil casting of a liquid, viscous, pasty or ductile matrix raw material.

As schematically shown in FIG. 3 and FIG. 4, included as an aspect of the invention, the texturing produced by the profiling element 26; 28; 25, 29; 30 forms transport channels 17 on the porous carrier material 4a; 4b for gaseous or liquid media, which serve the feeding or draw-off of the gas converted by the electrochemical energy converter.

The enlarged cross-section view in FIG. 3 of a flat-shaped porous carrier material 4a; 4b with a deposited electrode 1, 2, shows (macroscopic) gas transport channels 17 created by the texturing and located on the surface of the porous carrier material 4a; 4b opposite the respective electrodes 1; 2. Due to the porosity inside the porous structure, flow ways 16 are formed where the gas, for example fuel gas or the cathode gas of a fuel cell, is transported between the transport channels 17 and the respective electrode 1; 2.

FIG. 4 is a perspective illustration of the porous carrier material 4a; 4b, showing the course of the transport channels 17 on the surface of the porous structure. Instead of the demonstrated simple transport channels 17, the texturing in the porous carrier material 4a; 4b can also comprise more complex patterns.

### List of Reference Numbers

1 Anode

2 Cathode

3 Electrolyte matrix

4a; 4b Porous carrier material

16 Flow ways

17 Flow ways

18 Catalyst layer

22 Roller

24 Roller

25 Roller

26 Profiling element

28 Profiling element

29 Profiling

30 Profiling element

1. Method for the manufacture of electrodes, components, half-cells and cells for electrochemical energy converters, distinguished by the following process steps:
a) Fabricating a flat-shaped, porous carrier material (4a; 4b);
b) Depositing a minimum of one layer of electrode material (1; 2) and/or one layer of catalyst material (18) on the porous carrier material (4a; 4b);
c) Rolling or pressing the porous carrier material (4a; 4b), together with the layer of electrode material (1; 2) deposited thereon and/or the layer of catalyst material (18), to a predetermined thickness (d), and simultaneously producing a level and smooth or structured surface, while reducing the thickness of the carrier material (4a; 4b) and/or the layer of electrode material (1; 2).

2. Method according to claim 1, wherein in step c), the porous carrier material (4a; 4b), together with the layer of electrode material (1; 2) deposited thereon and/or the layer of catalyst material (18) are rolled or pressed to a predetermined thickness (d), which is smaller than their original thickness (D) prior to rolling or pressing.

3. Method according to claims 1 or 2, wherein texturing is produced in the porous carrier material (4a; 4b).

4. Method according to claim 3, wherein the texturing is produced by rolling or pressing with a profiling element (25, 29; 26; 28; 30) in step c).

5. Method according to claim 3, wherein the texturing is produced by rolling or pressing with a profiling element (25, 29; 26; 28; 30) in an additional step d).

6. Method according to claim 5, wherein rolling or pressing with the profiling element (25, 29; 26; 28; 30) in the additional step d) is performed subsequent to rolling or pressing according to step c).

7. Method according to claims 3, 4, 5 or 6, wherein the texturing forms transport channels (17) on the porous carrier material (4a; 4b), which serve the feeding or draw-off of the medium (gas) converted at the electrochemical energy converter.

8. Method according to one of the claims 4 through 7, wherein the profiling element that produces the texturing is formed by a roller (25) or a press part with a profiled surface (29).

9. Method according to one of the claims 4 through 7, wherein the profiling element that produces the texturing is a separate part (26; 28; 30), which is located between a roller (22; 24) or the press part and the porous carrier material (4a; 4b).

10. Method according to claim 9, wherein the profiling element (26; 28; 30) that produces the texturing is a grid or a flat-shaped profile.

11. Method according to claims 9 or 10, wherein the profiling element (30) that produces the texturing is plate-shaped.

12. Method according to claims 9 or 10, wherein the profiling element (26; 28) that produces the texturing is a rotating band, which rotates between the roller (22; 24) and the porous carrier material (4a; 4b).

13. Method according to one of the claims 1 through 12, wherein drying, firing, or sintering is performed prior to rolling or pressing.

14. Method according to one of the claims 1 through 13, wherein firing or sintering is performed subsequent to rolling or pressing.

15. Method according to one of the claims 1 through 14, wherein a layer of electrode material (1) is deposited on one side of the porous carrier material (4a), and that a layer of catalyst material (18) is deposited on the opposite side of the porous carrier material (4a).

16. Method according to one of the claims 1 through 15, wherein a layer of electrode material (2) is deposited on the porous carrier material (4b), and a layer of electrolyte matrix material (3) is deposited on the layer of electrode material (2).

17. Method according to one of the claims 1 through 16, wherein the flat-shaped, porous carrier material (4a; 4b) is produced by a carbonyl process, precipitation, galvanization or foaming.

18. Method according to one of the claims 1 through 17, wherein the layer of electrode material (1; 2) and/or the layer of catalyst material (18) are deposited by spraying a sprayable electrode raw material or a sprayable catalyst material.

19. Method according to one of the claims 1 through 17, wherein the layer of electrode material (1; 2) is deposited on the carrier material (4a; 4b) by applying a viscous or pasty electrode raw material.

20. Method according to one of the claims 1 through 17, wherein the layer of electrode material (1; 2) is deposited on the porous carrier material (4a; 4b) by casting, foil casting or dipping of a liquid electrode raw material.

21. Method according to one of the claims 1 through 20, wherein the layer of electrolyte matrix material (3) is deposited by spraying a sprayable matrix raw material.

22. Method according to one of the claims 1 through 20, wherein the layer of electrolyte matrix material (3) is deposited by applying casting or foil casting of a liquid, viscous, pasty or ductile raw material.

23. Implementation of a method according to one of the claims 1 through 22 for the manufacture of electrodes, components, half-cells or cells for a fuel cell arrangement.

24. Implementation of a method according to one of the claims 1 through 22 for the manufacture of electrodes, components, half-cells or cells for an electrolyte cell arrangement.
